(19) United States
(12) Patent Application Publication
(10) Pub. No.: US 2004/0122248 A1
(43) Pub. Date: Jun. 24, 2004

(54) Preparation of organometal compounds

(75) Inventors: Deodatta Vinayak Shenai-Khatkhate, Danvers, MA (US); Ronald L. Dicarlo JR., Newfields, NH (US); Michael L. Timmons, Durham, NC (US)

Correspondence Address: EDWARDS & ANGELL, LLP, P.O. Box 9169, Boston, MA, 02209, US

(73) Assignee: Shipley Company, L.L.C., Marlborough, MA (US)

(21) Appl. No.: 10/675,394

(22) Filed: Sep. 30, 2003

Related U.S. Application Data
(60) Provisional application No. 60/419,622, filed on Oct. 18, 2002.
(60) Provisional application No. 60/422,043, filed on Oct. 29, 2002.

(51) Int. Cl. C07F 5/02

(52) U.S. Cl. 556/7

(57) ABSTRACT

A method of preparing organometal compounds that does not use oxygenated solvents is provided. The compounds produced by such method are particularly useful as precursor compounds for metalorganic chemical vapor deposition processes used in the manufacture of electronic devices. Methods of depositing metal films using such organometal compounds are also provided.

### BACKGROUND OF THE INVENTION

The present invention relates generally to the field of organometallic compounds. In particular, this invention relates to the preparation of alkyl metal compounds which are suitable for use as precursors for chemical vapor deposition.

Metal layers may be deposited on surfaces, such as non-conductive surfaces, by a variety of means such as chemical vapor deposition (“CVD”), physical vapor deposition (“PVD”), and other epitaxial techniques such as liquid phase epitaxy (“LPE”), molecular beam epitaxy (“MBE”), and chemical beam epitaxy (“CBE”). Chemical vapor deposition processes, such as metalorganic chemical vapor deposition (“MOCVD”), deposit a metal layer by decomposing organometallic precursor compounds at elevated temperatures, i.e. above room temperature, either at atmospheric pressure or at reduced pressures. In conventional CVD processes, suitable precursor compounds must have a sufficient vapor pressure to allow them to be transported to the deposition chamber. Both solid and liquid precursor compounds are known.

A wide variety of metals may be deposited using such CVD or MOCVD processes. See, for example, Stringfellow, Organometallic Vapor Phase Epitaxy: Theory and Practice, Academic Press, 2^{nd} Edition, 1999, for an overview of such processes. For example, gallium is used in a variety of metal films produced by epitaxial growth, particularly in the manufacture of electronic devices such as integrated circuits and light emitting diodes (“LEDs”). Exemplary gallium containing metal films include gallium-arsenide (“GaAs”), indium-gallium-arsenide (“InGaAs”), aluminum-gallium-arsenide (“AlGaAs”), indium-gallium-aluminum-phosphide (“InGaAlP”), indium-gallium-arsenic-phosphide (“InGaAsP”), and indium-gallium-arsenide/gallium-arsenide/aluminum-gallium-arsenide (“InGaAs/GaAs/AlGaAs”). Gallium arsenide phosphide (“GaAsP”) is suitable for visible LED's and fiber optic emitters/detectors.

For semiconductor and electronic device applications, these organometallic precursor compounds must be highly pure and be substantially free of detectable levels of both metallic impurities, such as silicon and zinc, as well as oxygenated impurities. Oxygenated impurities are typically present from the solvents used to prepare such organometallic compounds, and are also present from other adventitious sources of moisture or oxygen.

Trialkyl gallium compounds are typically used as precursor compounds for the deposition of gallium. Such trialkyl gallium compounds are conventionally prepared by a transalkylation method such as by reacting a gallium trihalide with a trialkyl aluminum. The trialkyl gallium compounds generally contain small amounts of impurities such as aluminum, zinc and silicon, which are difficult to remove despite extensive purification procedures. Zinc is a p-type impurity and even a few parts per million may be detrimental in certain semiconductor applications. Dialkylzinc compounds, which are often present in trialkyl gallium compounds, can be very difficult to remove using conventional methods, such as distillation, due to the close proximity of their boiling points to the corresponding trialkyl gallium compound. Certain procedures have been developed in an effort to remove such zinc impurities, such as by contacting the trialkyl gallium compound with a metallic gallium-containing melt. Such contact may be achieved by refluxing the trialkyl gallium in the presence of the melt. This purification procedure adds greatly to the manufacturing costs of the trialkyl gallium compounds, such as reduced output and increased waste handling costs, and does not guarantee complete removal of the impurities.

For certain applications, such small amount of aluminum present in a trialkyl gallium compound is not problematic. However, where ultrapure gallium-containing layers are required, e.g. in blue LEDs, aluminum contamination can be a problem. For example, when such trialkyl gallium compounds are used to deposit a gallium nitride layer, the small amount of aluminum present will precipitate onto the growing film in the form of aluminum nitride. Conventionally, trialkyl gallium compounds produced by a transalkylation reaction with a trialkyl aluminum compound are subjected to numerous purification steps, such as multiple distillations, in order to attempt to remove as much of the aluminum impurity as possible. Such numerous purification steps greatly increase the manufacturing cost and do not completely remove the aluminum impurity. Also, the trialkyl aluminum starting materials are pyrophoric which makes handling them difficult and also increases the manufacturing costs. Such trialkyl aluminum starting materials also typically contain silicon impurities which are difficult to remove and causes problems in compound semiconductor applications.

Hupe et al., Mechanism of the Stereoselective Alkyl Group Exchange between Alkylboranes and Alkylzinc Compounds, Organometallics, vol. 21,pp 2203-2207 (2002), disclose the theoretical reaction of certain trialkylboranes with certain alkyl metal compounds, such as diisopropylzinc. Reactions of trialkylboranes with metal compounds other than alkyl metal compounds are not disclosed.

There is a need for a alkyl metal compounds, that are less costly to manufacture and can be prepared without the use of highly pyrophoric starting materials. There is an additional need for trialkyl gallium and trialkyl indium compounds having reduced or eliminated aluminum, zinc and silicon impurities.

### SUMMARY OF THE INVENTION

It has been found that certain organometal compounds, such as trialkyl gallium, can be prepared in high yield and in high purity starting from triorgano boron compounds. Such reactions are performed in ether-free solvents. The organometal compounds produced by this method are extremely pure and substantially free of oxygenated impurities.

The present invention provides a method of preparing organometal compounds including the step of reacting a triorgano boron compound with a metal halide compound, wherein the metal halide compound includes a metal selected from gallium, indium, aluminum, cadmium and zinc. Also contemplated by the present invention is an organometal compound free of oxygenated impurities; wherein the organometal compound includes a metal selected from gallium, indium, aluminum, cadmium and zinc. Preferred metal halide compounds are the metal dihalides and trihalides.

Also provided by the present invention is a method of depositing a metal layer including the steps of: a) conveying an organometal compound in the gaseous phase to a deposition chamber containing the substrate; b) decomposing the organometal compound in the deposition chamber; and c) depositing a metal layer on the substrate; wherein the organometal compound is free of oxygenated impurities; and wherein the metal is selected from gallium, indium, aluminum, cadmium and zinc.

The present invention further provides a method for manufacturing an electronic device including the step of depositing a metal layer on an electronic device substrate comprising the steps of: a) conveying an organometal compound in the gaseous phase to a deposition chamber containing the substrate; b) decomposing the organometal compound in the deposition chamber; and c) depositing a metal layer on the substrate; wherein the organometal compound is free of oxygenated impurities; and wherein the metal is selected from gallium, indium, aluminum, cadmium and zinc.

In addition, the present invention provides a method for preparing an organometal compound including the steps of: reacting a triorgano boron compound with a metal halide compound, wherein the metal halide includes a metal selected from gallium, indium, aluminum, cadmium and zinc, to form a boron halide compound and the organometal compound; isolating the boron halide compound; and reacting the boron halide compound with an organo aluminum compound or an alcohol.

### DETAILED DESCRIPTION OF THE INVENTION

As used throughout this specification, the following abbreviations shall have the following meanings, unless the context clearly indicates otherwise: ° C.=degrees centigrade; NMR=nuclear magnetic resonance; mol=moles; g=gram; L=liter; ca.=approximately; micron=micrometer; and mL=milliliter.

“Halogen” refers to fluorine, chlorine, bromine and iodine and “halo” refers to fluoro, chloro, bromo and iodo. Likewise, “halogenated” refers to fluorinated, chlorinated, brominated and iodinated. “Alkyl” includes linear, branched and cyclic alkyl. Likewise, the term “alkenyl” includes linear, cyclic and branched alkenyl. As used herein, “alkenyl” includes dienes. Unless otherwise noted, all amounts are percent by weight and all ratios are molar ratios. All numerical ranges are inclusive and combinable in any order except where it is clear that such numerical ranges are constrained to add up to 100%.

The present invention provides a method for preparing organometal compounds including the step of reacting a metal halide compound with a triorgano boron compound, wherein the metal is selected from gallium, indium, aluminum, cadmium and zinc. By “organometal compound” is meant any organic group-containing gallium, indium, aluminum, cadmium and zinc compound, such as trialkyl gallium compounds, dialkyl gallium halide compounds, alkyl gallium dihalide compounds, triaryl gallium compounds, trialkyl indium compounds, monoalkyl indium dihalide compounds, dialkyl indium halide compounds, triaryl indium compounds, trialkyl aluminum compounds, dialkyl aluminum halide compounds, alkyl aluminum dihalide compounds, triaryl aluminum compounds, dialkyl zinc compounds, alkyl zinc halide compounds, dialkyl cadmium compounds, alkyl cadmium halide compounds and the like. Preferably, such reaction is performed in an organic solvent free from oxygen substitution. Such organometal compounds are substantially free of oxygenated impurities and preferably free of such impurities. By “substantially free of oxygenated impurities” it is meant that the organic solvent contains ≦50 ppm of oxygenated impurities.

Suitable metal halide compounds are any that can be reacted with the triorgano boron compounds according to the present invention and include, without limitation, gallium halide compounds, indium halide compounds, cadmium halide compounds, and zinc halide compounds. As used herein, a metal halide compound is any metal compound containing one or more halogens. In particular, suitable metal halide compounds have the formula MYₐ wherein each Y is independently halogen, alkyl or aryl, a is the valence of the metal, and M is gallium, indium, aluminum, cadmium or zinc; wherein at least one Y is halogen. Chlorine and bromine are particularly useful halogens. M is typically gallium, indium, cadmium or zinc and more typically gallium, indium or zinc. Suitable alkyl groups for Y are (C₁-C₆)alkyl, preferably (C₁-C₄)alkyl, and more preferably (C₁-C₃)alkyl. When two or more Ys are alkyl, each such alkyl may be the same or different. Suitable aryl groups include, without limitation, phenyl, benzyl, biphenyl, and naphthyl. The aryl groups for Y may optionally be substituted, such as by replacing one or more hydrogens with a (C₁-C₆)alkyl. It will be appreciated by those skilled in the art that more than one metal compound may be used in the present invention.

Exemplary metal compounds include, but are not limited to, gallium trichloride, gallium tribromide, gallium triiodide, chlorodimethy gallium indium trichloride, indium tribromide, indium triiodide, cadmium dichloride, cadmium diiodide, cadmium dibromide, zinc dichloride, zinc dibromide, and mixtures thereof. Metal compounds containing mixed halogens may also be used. Such metal compounds are generally commercially available from a variety of sources or may be prepared by a variety of methods known in the literature.

A wide variety of organo boron compounds may be used. Exemplary triorgano boron compounds have the formula Z₃B, wherein each Z is independently selected from halogen, (C₁-C₆)alkyl, (C₁-C₆)alkenyl or aryl, provided that at least one Z is alkyl, alkenyl or aryl. Suitable alkyl groups include, but are not limited to, methyl, ethyl, propyl such as n-propyl and isopropyl, and butyl such as n-butyl, iso-butyl and tert-butyl. Particularly suitable alkyls include, methyl, ethyl, n-propyl and iso-propyl. Preferably, each Z is the same. Suitable aryl groups include, but are not limited to, phenyl, benzyl, biphenyl, and naphthyl. It will be appreciated by those skilled in the art that the alkyl or aryl group may optionally be substituted. By “substituted” it is meant that one or more of the hydrogens on the alkyl or aryl group are replaced by one or more substituent groups. Suitable substituent groups are those that do not contain oxygen and that do not adversely affect the reaction. Suitable substituent groups include, without limitation, (C₁-C₄)alkyl, di(C₁-C₄)alkyl amino, and phenyl. Triorgano boron compounds are generally commercially available from a variety of sources or may be prepared by a variety of methods known in the literature.

Typically, the metal halide compound is reacted with the triorgano boron compound in an organic solvent. A wide variety of organic solvents may optionally be used in the present invention, provided that such organic solvents do not contain oxygenated species. It is preferred that such organic solvents are free of oxygen substitution. It is further preferred that the organic solvents do not contain dissolved oxygen. Particularly suitable organic solvents include, but are not limited to, hydrocarbons and aromatic hydrocarbons. Exemplary organic solvents include without limitation benzene; alkyl substituted benzenes such as toluene, xylene, and (C₄-C₂₀)alkyl benzenes such as (C₁₀-C₁₂)alkyl benzenes; alkyl substituted naphthalenes such as 1,2-dimethylnaphthylene, and (C₁₀-C₂₀)alkyl biphenyls; and aliphatic hydrocarbons such as pentane, hexane, heptane, octane, decane, dodecane, nonadecane, octadecane, hexadecane, pentadecane, eicosane, squalane, cyclopentane, cyclohexane, and cycloheptane; and mixtures thereof. Typically, the organic solvent is benzene, toluene, xylene, (C₄-C₂₀)alkyl benzenes, hexane, heptane, cyclopentane or cyclohexane. It will be appreciated that more than one organic solvent may be advantageously used in the present invention. Such organic solvents are generally commercially available from a variety of sources. Such solvents may be used as is or, preferably, purified prior to use.

Preferably, such organic solvents are deoxygenated prior to use. The solvents may be deoxygenated by a variety of means, such as purging with an inert gas, degassing the solvent in vacuo, or a combination thereof. Suitable inert gases include argon, nitrogen and helium, and preferably argon or nitrogen.

The molar ratio of metal halide compound to trialkyl boron compound in the present invention is typically from 4:1 to 1:4, and preferably from 1:1 to 1:1.5, although greater and lesser ratios may be used. By controlling the molar ratio of the metal halide compound to the triorgano boron compound a variety of alkyl or aryl metal compounds can be prepared. Exemplary alkyl or aryl metal compounds that can be prepared by the present invention include without limitation monoalkyl gallium dihalide, dialkyl gallium halide, trialkyl gallium, triaryl gallium, monoalkyl indium dihalide, dialkyl indium halide, trialkyl indium, triaryl indium, monoaryl indium dihalide, dialkyl cadmium, monoalkyl zinc halide, and dialkyl zinc. Such alkyl metal compounds may be homoleptic or heteroleptic. Such molar ratio determination is well within the ability of those skilled in the art and will depend upon the particular organometal compound desired. Thus, the present invention also provides a method of preparing an organometal compound including the step of reacting a metal halide compound with a triorgano boron compound, optionally in the presence of an organic solvent free of oxygenated impurities, wherein the metal is selected from gallium, indium, aluminum, cadmium and zinc.

The use of metal halides as the starting metal compound results in the formation of boron halides, such as boron trihalides. When gallium, indium or aluminum trihalide or cadmium or zinc dihalide is used as the metal compound, the present transalkylation reaction produces an alkyl metal compound and boron trihalide. This reaction is illustrated by the following equation for gallium trichloride which is reacted with triethyl boron to form triethyl gallium and boron trichloride.

GaCl₃+(C₂H₅)₃B→(C₂H₅)₃Ga+BCl₃

Optionally, the reaction of the metal halide compound with the triorgano boron compound may be performed in the presence of a tertiary amine. For example, a tertiary amine may be used with a gallium compound, particularly when a gallium-nitride layer is desired. A wide variety of tertiary amines may be used in the present invention. Suitable tertiary amines include, but are not limited to, those having the general formula NR⁴R⁵R⁶, wherein R⁴, R⁵ and R⁶ are independently selected from (C₁-C₆)alkyl, di(C₁-C₆)alkylamino-substituted (C₁-C₆)alkyl, and phenyl and wherein R⁴ and R⁵ may be taken together along with the nitrogen to which they are attached to form a 5-7-membered heterocyclic ring. Such heterocyclic ring may be aromatic or non-aromatic. Exemplary tertiary amines include, but are not limited to, trimethylamine, triethylamine, tri-n-propylamine, tri-n-butylamine, tri-iso-propylamine, tri-iso-butylamine, dimethylaminocyclohexane, diethylaminocyclohexane, dimethylaminocyclopentane, diethylaminocyclopentane, N-methylpyrrolidine, N-ethylpyrrolidine, N-n-propylpyrrolidine, N-iso-propylpyrrolidine, N-methylpiperidine, N-ethylpiperidine, N-n-propylpiperidine, N-isopropylpiperidine, N,N′-dimethylpiperazine, N,N′-diethylpiperazine, N,N′-dipropylpiperazine, N,N,N′,N′-tetramethyl-1,2-diaminoethane, pyridine, pyrazine, pyrimidine, and mixtures thereof. Preferred amines include trimethylamine, triethylamine, tri-n-propylamine, triiso-propylamine, and tri-n-butylamine. In one embodiment, the tertiary amine is triethylamine or tri-npropylamine. It will be appreciated by those skilled in the art that more than one tertiary amine may be used in the present invention. Such tertiary amines are generally commercially available from a variety of sources. Such tertiary amines may be used as is or, preferably further purified prior to use. See U.S. Pat. No. 4,792,467 (Melas et al.) for a description of gallium-nitride film deposition.

In general, the metal halide compound, the triorgano boron compound, optional solvent and any other optional components, such as the tertiary amines described above, may be added to the reaction vessel in any order. The reaction mixture is typically stirred and degassed. The reaction mixture is then typically heated, such as from 30° to 250° C. and more typically from 40° to 150° C. The reaction mixture is allowed to react for a period of time sufficient to provide the desired organometal compound. When the reaction is preformed in a batch process, the reaction mixture is typically allowed to react for 0.5 to 48 hours, and preferably for 1 to 36 hours, and more preferably for 4 to 12 hours.

Alternatively, the present reaction may be performed in a continuous process. For example, the triorgano boron compound may be added to the reaction vessel in a continuous manner, such as by bubbling the triorgano boron compound through the metal halide compound or a solution containing the metal halide compound, while continuously distilling the desired organometal compound, such as using a conventional two-trap technique. The first trap is typically maintained at a temperature sufficient to condense the desired organometal compound but not sufficient to condense the boron compound by-product. The second trap is typically maintained at a temperature sufficient to condense the boron-compound by-product. In such continuous process, the metal halide compound starting compound is also continuously added to the reaction vessel, either neat or as a solution.

The boron halide by-products of the present method typically have low boiling points. For example, boron trichloride is typically a gas at room temperature. The present method is enhanced by removal, preferably continuous removal, of the boron halide produced. Preferably, such removal is achieved by distillation, but other suitable methods, such as liquid extraction, may be used. In an alternate embodiment, a catalytic amount of an amine, such as the tertiary amines described above, may be added to the reaction to react with the boron halide produced to help drive the reaction to completion.

Following reaction, the desired organometal compound is separated from the reaction solvent or reaction mixture by any suitable means such as extraction, distillation, or sublimation. Any extraction technique known in the art may suitably be used. For example, the organic reaction solvent may be removed completely, such as by distillation, to yield a concentrated reaction mixture. Such reaction mixture may then be contacted with a solvent for the organometal compound, or alternatively, a solvent for the unwanted material such as cyclopentane or cyclohexane, thereby leaving the organometal compound. In another embodiment, the organometal compound may be extracted from the organic reaction solvent using an extraction solvent. Any extraction solvent that dissolves the organometal compound is suitable. Exemplary extraction solvents include, but are not limited to, benzene, lower alkyl benzenes such as toluene, xylene including all isomers such as ortho-xylene, meta-xylene, and para-xylene, and trimethylbenzene including all its isomers.

When the organometal compound is extracted into the extraction solvent, the desired organometal compound is obtained by removing the extraction solvent such as by distillation. Alternatively, the organometal compound may be crystallized from the extraction solvent by a variety of known methods. For example, when trimethylindium is prepared according to the present process and extracted using a mixture of linear alkyl benzenes, the trimethylindium may be crystallized from the linear alkyl benzene solution by slowly adding a small amount of a nonsolvent, such as cyclopentane or cyclohexane. The organometal compound may be purified after recovery/isolation from the extraction solvent. In general, trialkylindium compounds are purified by sublimation in the presence of a fluoride salt, particularly potassium fluoride, in a small amount of solvent, such as squalane.

Alternatively, the organometal compounds may be separated from the reaction mixture by contacting the reaction mixture with an amine or phosphorous compound to form an adduct with the alkyl or aryl metal compound. Particularly useful amines are the tertiary amines described above. Such adduct may then be isolated, such as by crystallization, and subsequently dissociated, such as by heating, to provide the separated organometal compound. Such adduct isolation step may be performed in a quantitative or nearly quantitative yield.

A wide variety of organometal compounds may be prepared according to the present process. Exemplary organometal compounds have the formula RₐM, wherein each R is independently selected from (C₁-C₆)alkyl, (C₂-C₆)alkenyl, aryl or halogen, a is the valence of the metal, and M is a metal selected from gallium, indium, aluminum, cadmium and zinc. Preferably, R is (C₁-C₆)alkyl, and more preferably (C₁-C₄)alkyl. Exemplary organometal compounds include, but are not limited to, trimethylindium, triethylindium, tri-n-propylindium, tri-iso-propylindium, tri-iso-butylindium, tri-tert-butylindium, tri-n-butylindium, tri-n-hexylindium, trimethyl gallium, triethyl gallium, tri-iso-propyl gallium, tri-n-propyl gallium, tri-iso-butyl gallium, tri-tert-butyl gallium, tri-sec-butyl gallium, tri-neo-pentyl gallium, dimethyl zinc, diethyl cadmium, dimethyl cadmium, diethyl zinc, di-iso-propyl zinc, di-iso-butyl zinc and di-tert-butyl zinc. In particular, the present invention provides an ultrapure trialkyl gallium or trialkyl indium compound free of ethereal solvent, oxygenated impurities, silicon, aluminum and zinc. Preferred ultrapure trialkyl gallium and trialkyl indium compounds are selected from trimethyl gallium, triethyl gallium, tripropyl gallium, tributyl gallium, trimethyl indium, trimethyl indium, tripropyl indium and tributyl indium. The terms “tripropyl” and “tributyl” are meant to include all isomers of propyl and butyl, e.g. the n-, iso-, sec-, and tert-isomers as appropriate.

The present process provides numerous advantages over conventional organometal compound, particularly alkyl metal compound, preparation methods. These advantages include: easier processing of reaction products, lowered cost of raw materials per batch of organometal compounds, increased capacity of alkyl metal compound manufacture, increased yield of alkyl metal compounds, improved safety due to reduced handling of pyrophoric materials, and lower impurity incorporation in the final product. One disadvantage of conventional trialkylindium preparatory methods, such as those in U.S. Pat. No. 5,756,786, is that the high level of fluoride salt provides a suspension in the reaction vessel. Such suspension makes complete reaction of the starting materials difficult. In contrast, the present process provides a reaction mixture solution which allows easier handling and mixing of reaction components.

In an alternate embodiment, the present invention provides a method of preparing organometal compounds that allows for recycling or reuse of the reaction by-products. For example, boron trihalide produced by this reaction may be isolated and re-used, sold or easily converted into trialkyl boron or trialkyl borate compounds. The boron trihalide compounds may be reacted with trialkyl aluminum compounds, using conventional reaction conditions, to produce trialkyl boron compounds. Alternatively, the boron trihalide compounds may be reacted with an alcohol, such as methanol, to produce trialkyl borate, such as trimethyl borate. Such trialkyl boron compounds or trialkyl borate compounds may be further used as is, or may be further purified. Suitable applications for trialkyl borate include ceramics applications.

Accordingly, the present invention provides a method for preparing an organometal compound including the steps of: reacting a triorgano boron compound with a metal halide compound, wherein the metal halide includes a metal selected from gallium, indium, aluminum, cadmium and zinc, to form a boron trihalide compound and the organometal compound; isolating the boron trihalide compound; and reacting the boron trihalide compound with an organo aluminum compound or an alcohol. Such metal halide compound is preferably a metal dihalide or trihalide compound.

The organometal compounds of the present invention are suitable for use as chemical vapor deposition and/or metalorganic chemical vapor deposition precursor compounds. The compounds of the present invention are substantially free of oxygenated impurities, i.e. they contain ≦50 ppm of oxygenated impurities and preferably ≦25 ppm of such impurities. Trialkylindium and trialkyl gallium compounds produced by the present method are preferably substantially free of detectable levels of silicon, tin, aluminum, germanium and zinc, i.e. they contain <1 ppm and preferably <0.5 ppm of such impurities. More typically, such compounds are free of detectable levels of such impurities.

Indium, gallium, aluminum, cadmium or zinc films are typically deposited by first placing the desired indium, gallium, aluminum, cadmium or zinc precursor compound, or source compound, in a bubbler, or other delivery device suitable for delivering the compounds in the gaseous phase having an outlet connected to a deposition chamber. A wide variety of bubblers may be used and are well-known to those skilled in the art. A particularly useful bubbler for solid source compounds is that disclosed in U.S. Pat. No. 6,607,785 (Timmons et al.). The particular bubbler selected will depend in part on the particular deposition apparatus used. The source compound is maintained in the bubbler as a liquid or solid. Solid source compounds are typically liquefied or sublimed prior to transportation to the deposition chamber. The source compound is typically transported to the deposition chamber by passing a carrier gas through the bubbler. Suitable carrier gasses include nitrogen, hydrogen, and mixtures thereof. In general, the carrier gas is introduced below the surface of the source compound, and bubbles up through the source compound to the headspace above it, entraining or carrying vapor of the source compound in the carrier gas. The entrained or carried vapor then passes into the deposition chamber.

The deposition chamber is typically a heated vessel within which is disposed at least one, and possibly many, substrates. The deposition chamber has an outlet which is typically connected to a vacuum pump in order to draw by-products out of the chamber and to provide a reduced pressure where that is appropriate. MOCVD can be conducted at atmospheric or reduced pressure. The deposition chamber is maintained at a temperature sufficiently high to induce decomposition of the source compound. The typical deposition chamber temperature is from about 300° to about 1200° C., the exact temperature selected being optimized to provide efficient deposition. Such optimization is well within the ability of one skilled in the art. Optionally, the temperature in the deposition chamber as a whole can be reduced if the substrate is maintained at an elevated temperature, or if other energy such as radio frequency (“RF”) energy is generated by an RF source.

Suitable substrates for deposition may be any upon which a film including indium, gallium, aluminum, cadmium or zinc is desired, such as, but not limited to silicon such as silicon wafers used in integrated circuit manufacture, gallium arsenide, indium phosphate, and the like. Such substrates are particularly useful in the manufacture of integration circuits and light emitting diodes.

Deposition is continued for as long as desired to produce a film having the desired properties. Typically, the film thickness will be from several hundred to several thousand angstroms or more when deposition is stopped.

The present organometal compounds are useful in depositing any film including indium, gallium, aluminum, cadmium, zinc and alloys of any of these. Suitable films include, but are not limited to, indium, indium-phosphide (“InP”), GaAs, InGaAs, InGaAlP, InGaAsP, InGaAs/GaAs/AlGaAs, indium-arsenide (“InAs”), indium-antimonide (“InSb”) and indium-arsenic-bismuthide (“InAsBi”).

Thus, the present invention provides a method for depositing a metal layer on a substrate including the steps of: a) conveying an organometal compound in the gaseous phase to a deposition chamber containing the substrate; b) decomposing the organometal compound in the deposition chamber; and c) depositing a metal layer on the substrate; wherein the organometal compound is free of oxygenated impurities, and wherein the organometal compound includes a metal selected from gallium, indium, aluminum, cadmium and zinc. Also provided by the present invention is a method for manufacturing an electronic device including the step of depositing a metal layer on an electronic device substrate including the steps of: a) conveying an organometal compound in the gaseous phase to a deposition chamber containing the substrate; b) decomposing the organometal compound in the deposition chamber; and c) depositing a metal layer on the substrate; wherein the organometal compound is free of oxygenated impurities, and wherein the organometal compound includes a metal selected from gallium, indium, aluminum, cadmium and zinc. Such organometal compounds are typically trialkyl galliums, trialkyl indiums, trialkyl aluminums, dialkyl cadmiums, dialkyl zincs and mixtures thereof.

Suitable electronic devices include, but are not limited to, integrated circuits and light emitting diodes (“LEDs”).

The following examples are expected to illustrate various aspects of the present invention, but are not intended to limit the scope of the invention in any aspect.

### EXAMPLE 1

Five grams of gallium trichloride and 2.8 g of triethylboron (1:1 molar ratio) are added to a flask equipped with a condenser under a nitrogen atmosphere. The reaction is performed neat, i.e. no solvent is used. The reaction mixture is heated to 50° C. and maintained at that temperature for one hour. The reaction mixture is analyzed by FT-NMR and shows the presence of triethyl gallium: ¹H NMR; δ1.08 (CH₃, t) and 0.45 (CH₂, q). The chemical shifts for triethylboron are also distinguished at δ=0.91 (CH₃, t) and 1.12 (CH₂, q).

### EXAMPLE 2

Five grams of gallium trichloride and 4.2 g of triethylboron (2:3 molar ratio) are added to a flask equipped with a condenser under a nitrogen atmosphere. The reaction is performed neat. The reaction mixture is heated to 60° C. for one hour. A slight reflux is observed and a partial takeoff distillation head is attached to the flask to collect the refluxing material. The reaction flask is heated to 70° C. and a small amount of the refluxing material is collected. The reaction mixture and the distillate are analyzed by FT-NMR and show the presence of triethyl gallium.

### EXAMPLE 3

Fifteen grams of gallium trichloride and 8.4 g of triethylboron is added to a reaction flask equipped with a condenser under nitrogen. The reaction mixture is heated at 100° C. for three hours A partial takeoff distillation head is attached to the reaction flask. The reaction mixture is then heated to 90° C. A small amount of refluxing material is collected. The distillate and the refluxing material are analyzed by FT-NMR and show the presence of trimethyl gallium in the distillate.

### EXAMPLE 4

The procedure of Example 1 is repeated except that trimethyl boron is used instead of triethyl boron to produce trimethyl gallium.

### EXAMPLE 5

The procedure of Example 1 is repeated except that gallium tribromide is used and squalane is used as a solvent.

### EXAMPLE 6

The procedure of Example 4 is repeated except that gallium tribromide is used.

### EXAMPLE 7

The procedure of Example 1 is repeated except that tri-iso-propyl boron is used to produce tri-iso-propyl gallium.

### EXAMPLE 8

The procedure of Example 2 is repeated except that gallium triiodide and trimethyl boron are used to produce trimethyl gallium.

### EXAMPLE 9

The procedure of Example 7 is repeated except that tri-n-propyl boron is used to produce tri-n-propyl gallium.

### EXAMPLE 10

The procedure of Example 1 is repeated except that zinc dichloride is used instead of gallium trichloride to produce diethyl zinc.

### EXAMPLE 11

The procedure of Example 2 is repeated except that zinc dibromide is used instead of gallium trichloride to produce diethyl zinc.

### EXAMPLE 12

The procedure of Example 1 is repeated except that indium trichloride is used instead of gallium trichloride to produce triethyl indium.

### EXAMPLE 13

The procedure of Example 4 is repeated except that indium trichloride is used instead of gallium trichloride to produce triethyl indium.

### EXAMPLE 14

The procedure of Example 1 is repeated except that toluene is used as a solvent.

What is claimed is:

1. A method of preparing an organometal compound comprising the step of reacting a triorgano boron compound with a metal halide compound, wherein the metal halide compound comprises a metal selected from gallium, indium, aluminum, cadmium and zinc.

2. The method of claim 1 wherein the organometal compound is free of oxygenated impurities.

3. The method of claim 1 wherein the metal halide compound has the formula MYₐ wherein each Y is independently halogen, alkyl or aryl; a is the valence of the metal; and M is gallium, indium, aluminum, cadmium or zinc; and at least one Y is halogen.

4. The method of claim 3 wherein the metal halide compound is a metal trihalide metal compound.

5. The method of claim 1 wherein the triorgano boron compound has the formula Z₃B, wherein each Z is independently selected from halogen, (C₁-C₆)alkyl, (C₂-C₆)alkenyl or aryl, provided that at least one Z is alkyl, alkenyl or aryl.

6. The method of claim 1 further wherein the triorgano boron compound and the metal halide compound are reacted in an organic solvent.

7. The method of claim 6 wherein the organic solvent is free of oxygen substitution.

8. The method of claim 1 wherein the metal is gallium, indium, or zinc.

9. A method for preparing an organometal compound comprising the steps of: reacting a triorgano boron compound with a metal halide compound, wherein the metal halide comprises a metal selected from gallium, indium, aluminum, cadmium and zinc, to form a boron trihalide compound and the organometal compound; isolating the boron trihalide compound; and reacting the boron trihalide compound with an organo aluminum compound or an alcohol.

10. A method of preparing a trialkyl gallium compound comprising the step of reacting a trialkyl boron compound with a gallium trihalide compound.

11. The method of claim 10 wherein the gallium trihalide compound is selected from gallium trichloride, gallium tribromide and gallium triiodide.

12. The method of claim 10 wherein the trialkyl boron compound is selected from trimethyl boron, triethyl boron, tripropyl boron and tributyl boron.

13. A trialkyl gallium or trialkyl indium compound free of ethereal solvent, oxygenated impurities, silicon, aluminum and zinc.

14. The compound of claim 13 wherein the trialkyl gallium compound is selected from trimethyl gallium, triethyl gallium, tripropyl gallium and tributyl gallium.

15. The compound of claim 13 wherein the trialkyl indium compound is selected from trimethyl indium, trimethyl indium, tripropyl indium and tributyl indium.

16. A method of depositing a metal layer comprising the steps of: a) conveying a trialkyl gallium or trialkyl indium compound of claim 13 in the gaseous phase to a deposition chamber containing the substrate; b) decomposing the trialkyl gallium or trialkyl indium compound in the deposition chamber; and c) depositing a layer comprising gallium or indium on the substrate.

17. The method of claim 16 wherein the trialkyl gallium compound is selected from trimethyl gallium, triethyl gallium, tripropyl gallium and tributyl gallium.

18. The method of claim 16 wherein the trialkyl indium compound is selected from trimethyl indium, trimethyl indium, tripropyl indium and tributyl indium.
